(19) United States
(12) Patent Application Publication
(10) Pub. No.: US 2010/0225522 A1
(43) Pub. Date: Sep. 9, 2010

(54) SENSOR SYSTEM FOR DETECTING AN IMPENDING COLLISION OF A VEHICLE

(76) Inventor: Bernard Guy DeMersseman, Rochester Hills, MI (US)

Correspondence Address: AUTOLIV ASP, 3350 AIRORT ROAD, OGDEN, UT, 84405, US

(21) Appl. No.: 12/399,118

(22) Filed: Mar. 6, 2009

(51) Int. Cl. G01S 13/88; G01C 3/00

(52) U.S. Cl. 342/72; 356/3

(57) ABSTRACT

In at least one embodiment of the present invention, a sensor system for detecting an impending collision of a vehicle is provided. The sensor system comprises a radar arrangement providing a radar output based on a plurality of radar measurements. A vision arrangement provides a side-looking image to an occupant of the vehicle and a vision output based on a plurality of vision measurements. The vision measurements include presence of the object within a vision range and a vision closing velocity of the object with respect to the vehicle. In communication with the radar and vision arrangements is an electronic control module that is configured to produce an actuation signal for a safety device based upon evaluation of the radar and vision outputs.

### FIELD OF INVENTION

This invention relates to a sensor system for a motor vehicle impact protection system.

### BACKGROUND OF THE INVENTION

Enhancements in automotive safety systems over the past several decades have provided dramatic improvements in vehicle occupant protection. Presently available motor vehicles include an array of such systems, including inflatable restraint systems for the protection of occupants from frontal impacts, side impacts, and roll-over conditions. Advancements in belt restraints and vehicle interior energy absorbing systems have also contributed to enhancements in safety. Many of these systems must be deployed or actuated in a non-reversible manner upon the detection of a vehicle impact or rollover event to provide their beneficial effect. Many designs for such sensors are presently used to detect the presence of an impact or roll-over condition as it occurs.

Attention has been directed recently to providing pre-crash triggered deployable systems. For example, when an impact with an object is imminent, pre-crash triggered airbags can be deployed to reduce the severity of the impact to the occupant of the vehicle. This is because through deployment of the airbag system prior to impact, the inflated airbag can be better positioned to provide enhancements in the mechanical interaction between the occupant and the vehicle to provide greater energy absorption, thus reducing the severity of injuries to the vehicle occupant. A vehicle occupant protection system may further control a host of other systems when an imminent impact is detected, including deploying a motor driven belt pretensioner.

For the pre-crash triggered protection system to operate properly, a robust sensing system is necessary. Unlike crash sensors which trigger a deployment of a safety system while the vehicle is crushing and decelerating, the sensing system for a pre-crash triggered protection system must anticipate an impact before it has occurred. This critical “Time Before Collision” is related to the time to deploy the actuator or pyrotechnic device (e.g. 30-200 ms) and the clearance distance between the object and the vehicle (e.g. 100-800 mm). These parameters are particularly critical in side impact conditions. Inadvertent deployment of pyrotechnic safety devices is not only costly but may temporarily disable the vehicle. Moreover, since the deployment of many systems is achieved through a release of energy, deployment at an inappropriate time may result in undesirable effects.

Radar detection systems have been studied and employed for motor vehicles for many years. Radar systems for motor vehicles operate much like their aviation counterparts in that a radio frequency signal, typically in the microwave region, is emitted from an antenna on the vehicle and the reflected-back signal is analyzed to reveal information about the reflecting target. Such systems have been considered for use in active braking systems for motor vehicles, as well as obstacle detection systems for vehicle drivers. Radar sensing systems also have applicability in deploying external airbags. Radar sensors provide a number of valuable inputs, including the ability to detect the range of the closest object with a high degree of accuracy (e.g. 5 cm). They can also provide an output enabling measurement of a closing velocity to a target with high accuracy. The radar cross section of a target and the characteristics of the return signal may also be used as a means of characterizing the target.

Although information obtained from radar systems yield valuable data, exclusive reliance upon a radar sensor signal for deploying a pyrotechnic device, such as for example an airbag, has certain negative consequences. For example, radar sensor systems are prone to “false-positive” indications. These are typically due to phenomena such as a ground reflection, projection of small objects, and software misinterpretation, which faults are referred to as “fooling” and “ghosting.” For instance, a small metal object with a highly radar reflective geometry can return as much energy as a small car and as such can generate a collision signal in the radar even when the object is too small to damage the vehicle in a substantial way.

### BRIEF SUMMARY OF THE INVENTION

This invention is related to a sensing system for a pre-crash triggered safety system which may address the concerns discussed in the foregoing paragraphs.

In at least one embodiment of the present invention, a sensor system for detecting an impending collision of a vehicle is provided. The sensor system comprises a radar arrangement carried by the vehicle. A radar output based on a plurality of radar measurements including a radar range measurement and a radar closing velocity of an object with respect to the vehicle is provided by the radar arrangement. A vision arrangement is carried by the vehicle and provides a side-looking image to an occupant of the vehicle and a vision output based on a plurality of vision measurements. The vision measurements include presence of the object within a vision range and a vision closing velocity of the object with respect to the vehicle. In communication with the radar and vision arrangements is an electronic control module that is configured to produce an actuation signal for a safety device based upon evaluation of the radar and vision outputs.

In one aspect of the present invention, the radar measurement further includes a horizontal angular position of the object.

In another aspect of the present invention, the radar measurements further includes a radar cross section. The vision arrangement includes a vision sensor positioned on the vehicle for viewing a side proximity space adjacent to the side of the vehicle. In communication with the sensor is an image processing unit for providing an image of the side proximity space to the occupant of the vehicle and a vision output based on the plurality of vision measurements.

In yet another aspect of the present invention, the vision measurements further includes a physical size of the object.

These and other aspects and advantages of the present invention will become apparent upon reading the following detailed description of the invention in combination with the accompanying drawings.

### BRIEF DESCRIPTION OF THE DRAWINGS

FIG. 1a is a plan view of a representative motor vehicle incorporating a crash sensor system in accordance with an embodiment of the present invention;

FIG. 1b is a side view of the motor vehicle depicted in FIG. 1a;

FIG. 2 is a perspective view of a radar sensor in accordance with one embodiment of the present invention;

FIG. 3 is a signal and decision flow chart regarding a radar arrangement of a sensor system in accordance with an embodiment of the present invention;

FIG. 4 is a signal and decision flow chart regarding a vision arrangement of a sensor system in accordance with one embodiment of the present invention; and

FIG. 5 is a flow chart illustrating the integration of a radar output and a vision output to control a safety device in accordance with an embodiment of the present invention.

### DETAILED DESCRIPTION OF THE INVENTION

Detailed embodiments of the present invention are disclosed herein. It is understood however, that the disclosed embodiments are merely exemplary of the invention and may be embodied in various and alternative forms. The figures are not necessarily to scale; some figures may be configured to show the details of a particular component. Therefore, specific structural and functional details disclosed herein are not to be interpreted as limiting but merely as a representative basis with the claims and for teaching one skilled in the art to practice the present invention.

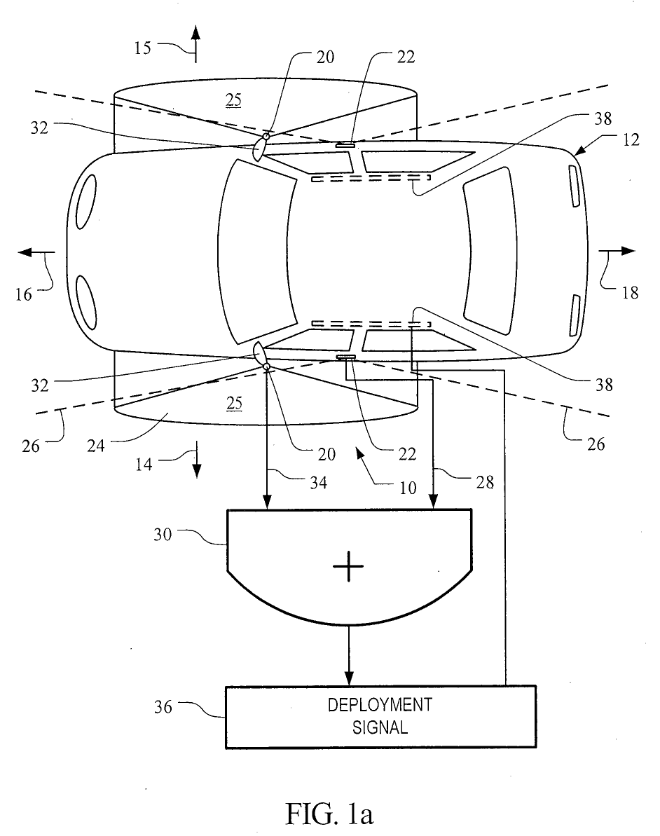

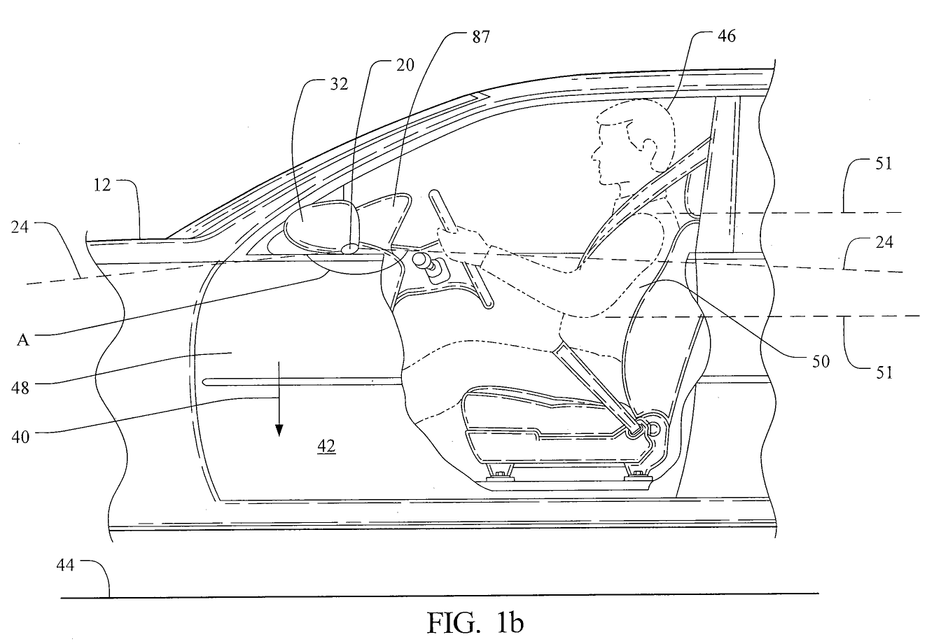

Now referring to FIG. 1a, a sensor system 10 is shown with an associated vehicle 12. The sensor system 10 is configured for a left and/or right side-looking 14 and 15 application. However, the sensor system 10 may be configured for a forward-looking 16 or rearward-looking 18 application with the same ability to sense an approaching object and prepare the vehicle 12 for a crash. In the side-looking 14 application, the sensors 20 and 22 may be positioned looking sideways relative to the vehicle 12 so as to have overlapping fields of view 24 and 26 as shown.

The sensor system 10 includes a radar sensor 22 that is configured to transmit and receive radio frequency signals, preferably in the microwave range. For example, the sensor 22 may transmit and receive signals via a antenna-transceiver arrangement operating at 24 Ghz, 77 Ghz or 79 Ghz. The radar sensor 22 is further configured to provide a radar output 28, e.g. electrical signal/s, to an electronic control module (ECM) 30.

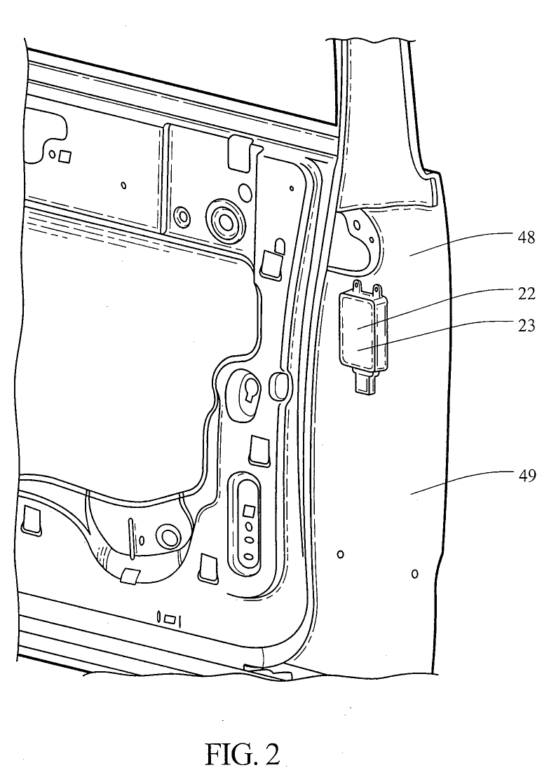

Referring to FIGS. 1a and 2, the radar sensor 22 may be part of a radar module 23 which is mounted, for example, to a door 48, preferably on an inside surface. The door panel 49 may be made of a dielectric material or have a dielectric window through which the radio frequency signals may be transmitted and received by the sensor 22 for detecting a potential collision with an object. Other suitable locations on the vehicle 12 for mounting the radar sensor 22 for detecting an impending collision may also be used.

As part of the sensor 22, the module 23 may contain at least one antenna (not shown), a microwave oscillator (not shown), an amplifier (not shown), a mixer (not shown) and a base-band controller or processing unit (not shown). Such radar sensors 22 are generally well-known and accordingly, any other suitable configuration for the radar sensor 22 known to those skilled in the art may also be used.

A vision sensor 20 or camera, e.g. CMOS camera, is mounted to the vehicle 12. In at least one embodiment, the vision sensor 20 is mounted to a side portion of the vehicle 12, such as for example, a side view mirror assembly 32. The vision sensor 20 provides a vision output 34 to the ECM 30. The ECM 30 combines the radar output 28 and the vision output 34 to generate a deployment decision for producing a deployment or actuation signal 36 for deployment and/or actuation of a safety device 38. It should be noted that deployment signal may be used interchangeably with actuation signal regarding either deployment and/or actuation of a safety device.

Now with reference to FIG. 1b, the vision sensor 20 may be mounted to the side view mirror assembly 32 of the vehicle 12 viewing generally downward 40 and slightly sideways along the side 42 of the vehicle to generate a side-looking 14 image including an image of a road surface 44 and a lower side of the vehicle 42. The side-looking 14 image is provided to an occupant 46 of the vehicle for viewing, such as for example, via a monitor or other suitable display mounted inside the vehicle 12, e.g., to an instrument panel 87. The side-looking 14 image may be used for various driver convenience applications, such as for example, a parking aid, lane change assist, and/or a blind spot vehicle detection application.

In at least one example, the vision sensor 20 has a very wide field of view 24 having an angle ‘A’ of at least 120 degrees. Preferably, the wide field of view 24 covers the immediate proximity near the door 48 of the vehicle 12 at a height 51 corresponding to the occupant's thorax 50.

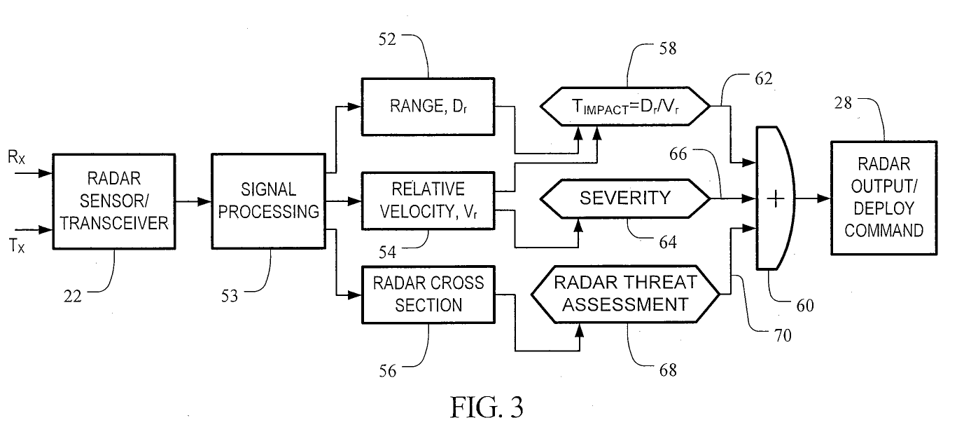

Now with reference to FIG. 3, a diagram of the signal and decision flow related to the radar sensor 22 is provided. The radar sensor 22 analyzes a radio frequency signal reflected off an object, e.g., via a signal processor 53, to obtain a range measurement 52, a closing velocity 54 and a radar cross section 56.

A time of impact estimate 58 is calculated based on the range measurement 52 and the closing velocity 54. The range measurement 52 is the distance between the object and the vehicle 12. The radar sensor 22 provides distance information with high accuracy, typically within 5 cm. The closing velocity 54 is a measure of the relative speed between the object and the vehicle 12. The time of impact estimate 58 is provided to block 60 along input 62. The time of impact estimate 58 is compared with the necessary time to deploy the safety device 38. The safety device 38 may be, for example, a side airbag, an inflatable curtain, a pyrotechnic device in the door 48, a seatbelt pretensioner, a brake actuator or some other pyrotechnic device for protecting the occupant 46. Typically, deployment time of a side airbag is between 100 ms and 300 ms.

The closing velocity 54 is also used to determine the severity of impact as denoted by block 64. High closing velocities are associated with a more severe impact, while lower closing velocities are associated with a less severe impact. The severity of impact calculation is provided to block 60 as input 66.

The radar cross section 56 is a measure of the strength of the reflected radio frequency signal. The strength of the reflected signal is generally related to the size and shape of the object. The size and shape is used to assess the threat of the object, as denoted by block 68. The threat assessment from block 68 is provided to block 60 as input 70. Block 60 of the ECM 30 processes the time of impact 58, severity of impact 64, and threat of assessment 68 to provide the radar output 28, which is indicative of a deployment command when these inputs meet predetermined criteria for indicating an impending collision with the object.

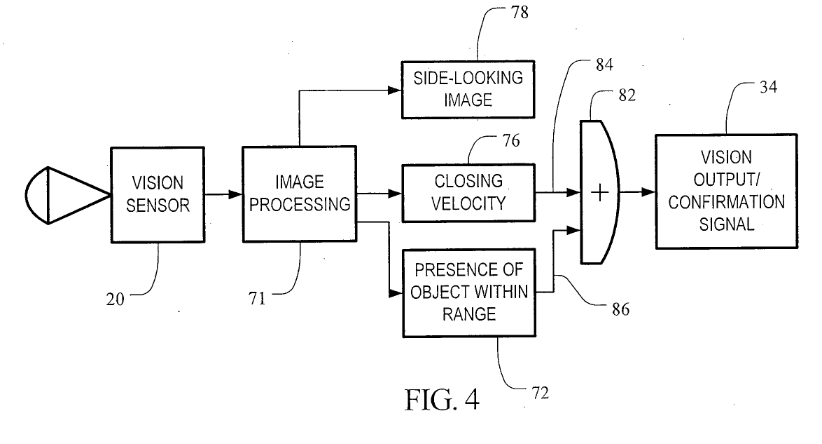

Now with reference to FIG. 4, a signal and decision flow relating to the processing of information from the vision sensor 20 is provided. The vision sensor 20 includes and/or is in communication with an imaging processing unit 71 to provide both the side-looking 14 image at block 78 to the occupant 46 and a plurality of vision measurements. In one example, the image processing unit 71 is a low noise CMOS imager with a high dynamic range capability of up to 100 frames per second. In another example, the image processing unit 71 is centralized and processes images from two vision sensors 20 which are positioned on different sides of the vehicle 12, e.g., opposing left-hand and right-hand sides of the vehicle 12. Included in the vision measurements are presence of the object within a vision range measurement 72 and a vision closing velocity 76 of the object with respect to the vehicle 12.

A presence of the object within a vision range measurement 72 is indicative of an object being present and detected, e.g., detected via the image processing unit 71, within a vision range of the sensor 20. The vision range of the sensor 20 may be limited by the field of view 24 and/or the direction of viewing, e.g., viewing downward 40 and slightly sideways 14, so as to define an outer perimeter of a proximity space 25 (see FIGS. 1a and 1b) adjacent to the vehicle 12. Alternatively, the vision range may be a predetermined distance that is less than the viewing range capability of the vision sensor 20. The predetermined distance may be programmed into or otherwise communicated to the image processing unit 71. The presence of the object measurement 72 is provided to block 82 as input 84. A vision closing velocity 76 is also determined (e.g. via processing optical flow) and is provided to block 82 as input 86. Block 82 of the ECM 30 processes the presence of the object measurement 72 and the vision closing velocity 76 to provide the vision output 34, which is indicative of a confirmation signal when these inputs satisfy predetermined criteria for confirming that a collision with the object will likely occur.

In one example, the vision sensor 20 is a stereo pair of cameras or a light modulating three dimensional imaging sensor. The vision sensor 20 can determine the presence of the object within the vision range 72, the relative closing velocity 76 of the object to the vehicle and the physical size of the object. In this scenario, the physical size of the object may be used to determine whether the presence of the object measurement 72 may be disregarded and therefore, no confirmation signal is generated, such as when the size of the object is too small that a collision with the object is unlikely to damage the vehicle 12 in a substantial way.

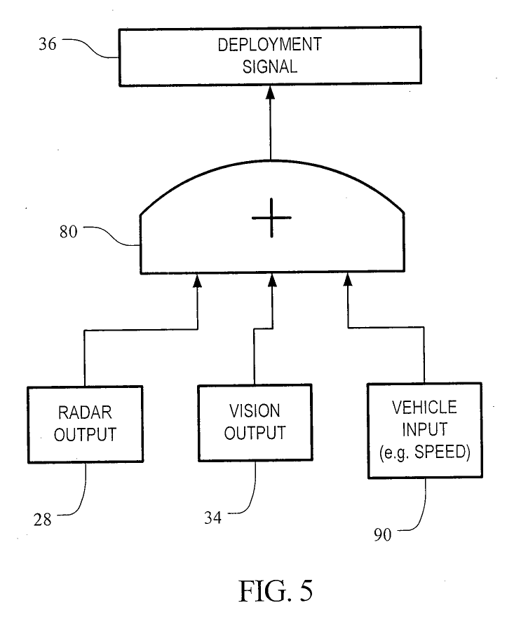

FIG. 5 illustrates the integration of the radar output 28 and the vision output 34 to provide the deployment or actuation signal 36. In one example, the radar and vision outputs 28 and 34 are exclusively used to determination whether to produce the deployment signal 36. For example, the ECM 30 considers decision outputs from both sensors 20 and 22 in block 80 and applies a basic function to arrive at a deployment decision to produce the deployment signal 36. The ECM 30 may be programmed to generate the deployment signal 36 only when the radar output 28 indicates an impending collision and the vision output 34 confirms the impending collision, thereby increasing reliability of determining the impending collision.

Alternatively, the radar output 28 and the vision output 34 may be considered along with vehicle parameters 90, which may include for example, vehicle speed, yaw rate, steering angle and steering rate. The vehicle parameters 90 are evaluated in conjunction with the radar output 28 and the vision output 34 to enhance the reliability of the decision to generate the deployment signal 36.

In at least one embodiment, the deployment command corresponds to radar measurements having a radar closing velocity 54 of at least about 10 meters pre second and a time to impact 58 of less than about 50 ms. The time to impact 58 is evaluated using the radar range measurement 52 and the radar closing velocity 54. The confirmation signal corresponds to the vision measurement indicating the presence of the object within the vision range 72 of about 1 meter or less from the vehicle with a closing velocity 76 of the object of at least about 10 kilometers per hour.

In an alternative embodiment, dedicated hardware implementations, such as application specific integrated circuits, programmable logic arrays and other hardware devices, can be constructed to implement one or more of the arrangements described herein. Applications that may include the sensors and arrangements of various embodiments can broadly include a variety of electronic and computer systems. One or more embodiments described herein may implement functions using two or more specific interconnected hardware modules or devices with related control and data signals that can be communicated between and through modules, or portions of an application-specific integrated circuit. Accordingly, the present system encompasses software, firmware, and hardware implementations.

As a person skilled in the art will readily appreciate, the above description is meant as an illustration of implementation of the principles of this invention. This description is not intended to limit the scope or application of this invention in that the invention is susceptible to modification, variation, and change, without departing from the spirit of this invention, as defined in the following claims.

1. A sensor system for detecting an impending collision of a vehicle, the sensor system comprising:
a radar arrangement carried by the vehicle for providing radar output based on a plurality of radar measurements including a radar range measurement and a radar closing velocity of an object with respect to the vehicle;
a vision arrangement carried by the vehicle for providing a side-looking image to an occupant of the vehicle and a vision output based on a plurality of vision measurements including presence of the object within a vision range and vision closing velocity of the object with respect to the vehicle; and
an electronic control module in communication with the radar and vision arrangements and configured to produce an actuation signal for a safety device which is dependent upon evaluation of the radar and vision outputs.

2. The sensor system according to claim 1 wherein the vision arrangement includes a vision sensor positioned on the vehicle for viewing a side proximity space adjacent to a side of the vehicle.

3. The sensor system according to claim 2 wherein the vision sensor is mounted to a side view mirror assembly of the vehicle viewing generally downward and along the side of the vehicle to provide the side-looking image including an image of a road surface and a lower side of the vehicle.

4. The sensor system according to claim 2 wherein the vision arrangement further includes an image processing unit in communication with the vision sensor for processing image signals from the vision sensor to provide the plurality of vision measurements.

5. The sensor system according to claim 2 wherein the vision sensor has a field of view of at least about 120 degrees.

6. The sensor system according to claim 2 wherein the vision sensor is one of a stereo vision sensor and a light modulating 3 dimensional imaging sensor.

7. The sensor system according to claim 1 wherein the safety device is one or more of a side airbag, an inflatable curtain, a pyrotechnic device in a vehicle door, a seatbelt pretensioner and a brake actuator.

8. The sensor system according to claim 1 wherein the radar measurements further includes at least one of a radar cross section measurement and an angular position of the object.

9. The sensor system according to claim 1 wherein the radar arrangement includes a radar sensor positioned on the vehicle for detecting in a generally sideways direction from the vehicle.

10. The sensor system according to claim 9 wherein the radar sensor is mounted to a vehicle door.

11. The sensor system according to claim 9 wherein the radar sensor operates in a microwave region.

12. The sensor system according to claim 1 wherein the electronic control module generates the actuation signal based on vehicle parameters including at least one of a vehicle speed and a yaw rate value.

13. The sensor system according to claim 1 wherein the electronic control module is configured to use the radar output as a deployment command and to use the vision output as a confirmation signal, producing the actuation signal and increasing reliability of determining an impending crash.

14. The sensor system according to claim 13 wherein the deployment command corresponds to the radar measurements having the radar closing velocity of at least about 10 meters/second and a time to impact of less than about 50 milliseconds, the time to impact being evaluated using the radar range measurement and the radar closing velocity.

15. The sensor system according to claim 13 wherein the confirmation signal corresponds to the vision measurements indicating the presence of the object within the vision range with the vision closing velocity of at least about 10 kilometers/hour, the vision range being about 1 meter or less from the vehicle.

16. The sensor system according to claim 1 wherein the vision measurements further includes a physical size of the object.

17. A sensor system for detecting an impending collision of a vehicle, the sensor system comprising:
a radar arrangement including a radar sensor positioned on the vehicle for detecting in a generally sideways direction from the vehicle, the radar arrangement for providing radar output based on a plurality of radar measurements including a radar cross section, a radar range measurement and a radar closing velocity of an object with respect to the vehicle;
a vision arrangement including a first vision sensor positioned on the vehicle for viewing a side proximity space adjacent to a side of the vehicle and an image processing unit in communication with the first vision sensor for providing an image of the side proximity space to an occupant of the vehicle and a vision output based on a plurality of vision measurements including presence of the object within a vision range and vision closing velocity of the object with respect to the vehicle; and
an electronic control module in communication with the radar and vision arrangements and configured to produce an actuation signal for a safety device which is dependent upon evaluation of the radar and vision outputs.

18. The sensor system according to claim 17 wherein the first vision sensor is mounted to a side view mirror assembly of the vehicle viewing generally downward and along the side of the vehicle to provide the side-looking image including an image of a road surface and a lower side of the vehicle.

19. The sensor system according to claim 17 wherein the first vision sensor has a field of view of at least about 120 degrees, defining the side proximity space including an area adjacent to a door of the vehicle at a height corresponding to a thorax of the occupant.

20. The sensor system according to claim 17 further including a second vision sensor positioned on an opposing side of the vehicle from the first vision sensor, the second vision sensor for viewing a second side proximity space adjacent to the opposing side of the vehicle, the image processing unit in communication with the second vision sensor for providing an image of the second side proximity space to the occupant and a second vision output based on a plurality of second vision measurements and the electronic control module in communication with the second vision arrangement for evaluating the second vision output.

21. The sensor system according to claim 17 wherein the electronic control module is configured to use the radar output as a deployment command and to use the vision output as a confirmation signal, producing the actuation signal and increasing reliability of determining an impending crash, and wherein the deployment command corresponds to the radar measurements having the radar cross section of at least about 5 m², the radar closing velocity of at least about 10 meters/second and a time to impact of less than about 50 milliseconds, the time to impact being evaluated using the radar range measurement and the radar closing velocity, and the confirmation signal corresponds to the vision measurements indicating the presence of the object within the vision range, which is about 1 meter or less from the vehicle, with the vision closing velocity of at least about 10 kilometers/hour.

22. The sensor system according to claim 17 wherein the vision range defines an outer perimeter of the side proximity space.
